(19) United States
(12) Patent Application Publication
(10) Pub. No.: US 2024/0356105 A1
(43) Pub. Date: Oct. 24, 2024

(54) Direct Water-Cooling Battery Module

(71) Applicant: LG Energy Solution, Ltd., Seoul (KR)

(72) Inventors: Jong Yoon Keum, Daejeon (KR); Bum Choi, Daejeon (KR); Sae Weon Roh, Daejeon (KR); Jae Heon Chung, Daejeon (KR); Min Yong Jung, Daejeon (KR)

(73) Assignee: LG Energy Solution, Ltd., Seoul (KR)

(21) Appl. No.: 18/685,634

(22) PCT Filed: Dec. 21, 2022
(86) PCT No.: PCT/KR2022/020916

§ 371 Date: Feb. 22, 2024

(30) Foreign Application Priority Data
Dec. 21, 2021 (KR) 10-2021-0183748

(51) Int. Cl. H01M 10/6567; H01M 10/613; H01M 10/6554; H01M 50/119; H01M 50/124; H01M 50/141

(52) U.S. Cl. CPC H01M 10/6567; H01M 10/613; H01M 10/6554; H01M 50/119; H01M 50/1245; H01M 50/141

(57) ABSTRACT

A direct water-cooling battery cell is capable of directly cooling heat generated in a battery cell by using non-insulated low-cost general cooling water, rather than insulated. expensive special cooling water. A direct water-cooling battery module comprising a plurality of the direct water-cooling battery cells is also provided.

### CROSS-REFERENCE TO RELATED APPLICATIONS

The present application is a national phase entry under 35 U.S.C. § 371 of International Application No. PCT/KR2022/020916 filed Dec. 21, 2022, which claims the benefit of Korean Patent Application No. 10-2021-0183748 filed on Dec. 21, 2021, with the Korean Intellectual Property Office, the entire contents of which are incorporated herein by reference.

### BACKGROUND OF THE INVENTION

### Technical Field

The present disclosure relates to a direct water-cooling battery cell and a direct water-cooling battery module comprising the same. Specifically, a direct water-cooling battery cell is capable of directly cooling a battery cell by using an non-insulated, low-cost general cooling water, rather than an insulated, expensive special cooling water A direct water-cooling battery module comprises the same.

### Background Art

An eco-friendly vehicle using electric energy receives power from an external charging facility to charge batteries installed in the vehicle, and uses the charged power of the batteries to produce kinetic energy required to drive the vehicle.

Batteries used in such eco-friendly vehicles generate a large amount of heat because high power is required. In order to improve battery performance and lifespan, it is essential to efficiently discharge heat generated from the battery, thereby preventing the batteries from overheating.

A direct air-cooling method, an indirect water-cooling method, or a direct water-cooling method, and the like are known in the art as conventional cooling systems for dissipating heat from a battery.

The direct air-cooling method is a method of directly supplying cooling air between a plurality of cells constituting a battery.

The indirect water-cooling method is a method of providing a channel through which cooling water flows on one side of a battery, and disposing a cooling plate in contact with the cooling channel between a plurality of cells to indirectly discharge heat from the battery cells to the cooling channel.

The direct water-cooling method is a method of directly immersing battery cells in cooling water to directly discharge heat from the battery cells into the cooling water.

FIG. 1 schematically illustrates a configuration diagram of a conventional battery module according to the prior art.

Referring to FIG. 1, a direct water-cooling type battery module (10) comprises a cell frame (11) and a plurality of battery cells (12). The plurality of battery cells (12) is disposed apart from each other inside the cell frame (11). The cell frame (11) is provided so that cooling water can flow into a space between the plurality of battery cells.

For example, the battery cell may be a cylindrical battery cell. In a conventional cylindrical battery cell, an exterior case for accommodating an electrode assembly is made of nickel-plated iron. Accordingly, when the battery cell (10) is immersed with cooling water, it is vulnerable to corrosion due to the material characteristics of the exterior case, and particularly, it is also weak in electrical insulation because the exterior case is polar.

Accordingly, conventional direct water-cooling battery modules use insulating oil or special cooling water (M) (e.g., 3M's NOVEC) inside the cell frame to prevent corrosion of the battery cells. However, such insulating oil used as cooling water is potentially vulnerable to ignition.

The special cooling water (M) such as 3M NOVEC is non-polar, thereby being excellent as cooling water for battery cells, albeit it increases the manufacturing cost of the battery module (10) due to its high price point.

### BRIEF SUMMARY OF THE INVENTION

### Technical Problem

The present disclosure is intended to provide a direct water-cooling battery cell capable of cooling a battery cell using low-cost, general cooling water instead of insulated, expensive special cooling water, and a direct water-cooling battery module comprising the same.

Also, the present disclosure is intended to provide a direct water-cooling battery cell capable of improving corrosion resistance of the battery cell by forming a case of the battery cell with a non-polar material, and a direct water-cooling battery module comprising the same.

In addition, the present disclosure is intended to provide a direct water-cooling battery cell capable of securing insulation performance of the battery cell by performing, even if a case of the battery cell is polar, non-polar treatment on the outer surface of the case with a resin layer having insulation properties, and a direct water-cooling battery cell including the same.

### Technical Solution

In order to solve the above problems, according to one aspect of the present invention, a battery module is provided, which comprises a plurality of battery cells including an electrode assembly, and a case accommodating the electrode assembly and formed of a non-polar material; a cell frame provided that the plurality of battery cells are spaced apart and disposed, and cooling water can flow between the plurality of battery cells; and a cooling water supply part for supplying the cooling water to the inside of the cell frame.

Also, the cooling water supply part may be provided to supply non-insulated cooling water. In addition, the battery module may further comprise a cooling water discharge part for discharging the cooling water inside the cell frame to the outside of the cell frame.

Furthermore, the case may be formed of aluminum.

Also, the battery module may comprise a waterproof layer provided inside the cell frame, and provided to cover upper side and lower side ends of the case, respectively.

In addition, the waterproof layer may comprise a waterproof adhesive or a potting resin.

Furthermore, the potting resin may be any one of a silicone-based resin, a urethane-based resin, or an epoxy-based resin.

Also, the case may comprise no nickel-plated layer.

In addition, according to another aspect of the present invention, a battery module is provided, which comprises a plurality of battery cells including an electrode assembly, a case accommodating the electrode assembly, and a resin layer surrounding the case; a cell frame provided that the plurality of battery cells are spaced apart and disposed, and cooling water can flow between the plurality of battery cells; and a cooling water supply part for supplying the cooling water to the inside of the cell frame.

Furthermore, the resin layer may be formed of a polymer sheet.

Also, the resin layer may be formed by thermally compressing the polymer sheet on the outer surface of the case.

In addition, the polymer sheet may be formed of at least one of polyvinylchloride, polypropylene, and polyethylene terephthalate.

Furthermore, the cooling water supply part may be provided to supply non-insulated cooling water.

Also, the case may be formed of aluminum.

In addition, the battery module may comprise a waterproof layer provided inside the cell frame, and provided to cover upper side and lower side ends of the case, respectively.

Furthermore, the case may comprise no nickel-plated layer.

### Advantageous Effects

As described above, a direct water-cooling battery cell related to at least one example of the present invention and a battery module comprising the same have the following advantageous effects.

Heat generated from a battery cell can be cooled by using low-cost, general cooling water instead of insulated, expensive special cooling water.

Also, by forming the case of the battery cell with the non-polar material, it is possible to improve the corrosion resistance of the battery cell. That is, as the case outer surface of the battery cell has non-polar properties, even if the battery cell is immersed in the cooling water for a long time, corrosion resistance and insulation properties can be maintained, and the heat generated from the battery cell can be cooled using general cooling water instead of the insulated special coolant.

In addition, even when the case of the battery cell is polar, it is possible to secure insulation performance of the battery cell by non-polarizing the outer surface of the case with a resin layer having insulation properties.

Compared to a conventional battery module using an insulated cooling water, which is prone to potential ignition, the battery modules disclosed herein are resistant to ignition, as a general cooling water is used.

Furthermore, the battery cell can be cooled using low-priced cooling water for general vehicles, so that the manufacturing cost of the battery module can be reduced.

### BRIEF DESCRIPTION OF THE DRAWINGS

FIG. 1 is a side view of a conventional battery module according to the prior art.

FIG. 2 is a side view of a direct water-cooling battery module according to an example of the present disclosure.

FIG. 3 is a perspective view of a battery cell according to an example of the present disclosure.

FIG. 4 is a side view of a direct water-cooling battery module according to an example of the present disclosure.

FIG. 5 is a perspective view of a battery cell according to an example of the present disclosure.

FIG. 6 is a cross-sectional diagram of a battery cell according to an example of the present disclosure.

### DETAILED DESCRIPTION OF THE PREFERRED EMBODIMENTS

Hereinafter, a direct water-cooling battery cell according to one example of the present disclosure, and a direct water-cooling battery module comprising the same will be described in detail.

In addition, regardless of the reference numerals, the same or corresponding components are denoted by the same or similar reference numerals, duplicate descriptions thereof will be omitted, and for convenience of explanation, the size and shape of each component member as shown can be exaggerated or reduced.

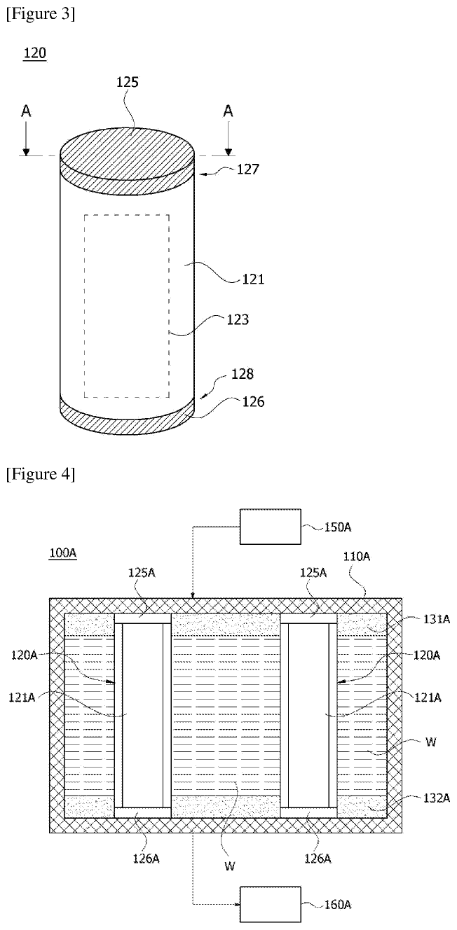

FIG. 2 is a diagram for schematically explaining a configuration diagram of a direct water-cooling battery module according to one example of the present disclosure, and FIG. 3 schematically illustrates a perspective diagram of a battery cell according to one example of the present disclosure.

Referring to FIGS. 2 and 3, the direct water-cooling battery module (100) according to a first example of the present disclosure will be described.

The battery module (100) comprises a plurality of battery cells (120), and a cell frame (120) that the plurality of battery cells is disposed within.

The battery module (100) comprises a plurality of battery cells (120) including an electrode assembly (123) and a case (121) accommodating the electrode assembly (123) and formed of a non-polar material; a cell frame (110) provided that the plurality of battery cells (120) is spaced apart and disposed therein, and cooling water (W) can flow between the plurality of battery cells; and a cooling water supply part (150) for supplying the cooling water (W) to the inside of the cell frame (110). The cooling water (W) may be supplied to the inside of the cell frame (110), and then discharged to the outside of the cell frame (110), and to this end, the battery module (100) may comprise a cooling water discharge part (160) for discharging the cooling water (W) to the outside of the cell frame (110). The cooling water supply part (150) may comprise a cooling water storage tank and a pump.

The direct water-cooling battery cell (120) comprises an electrode assembly (123) and a case (121) surrounding the electrode assembly (123). The electrode assembly (123) is accommodated in the case (121), and comprises a positive electrode, a negative electrode, and a separator disposed between the positive electrode and the negative electrode. The electrode and the separator may constitute an integrated electrode assembly. For example, the electrode assembly (123) may be a jelly-roll type electrode assembly in which sheet-type positive and negative electrodes are wound in a state where a separator is interposed therebetween, a stack type electrode assembly in which pluralities of positive and negative electrodes are sequentially stacked in a state where a separator is interposed therebetween, or a stack/folding type electrode assembly in which unit cells obtained by stacking positive and negative electrodes in predetermined units in a state where a separator is interposed therebetween are sequentially wound in a state where they are positioned on a separation film.

In addition, the case (121) serves to accommodate the electrode assembly (123), and to protect the battery cell from external impacts. The case may be cylindrical, pouch, or angular. In particular, the electrode assembly may be a rolled jelly-roll type electrode assembly, and the case may be a cylindrical case to accommodate the rolled jelly-roll type electrode assembly.

The direct water-cooling battery module (100) comprises a cell frame (110), a plurality of battery cells (120) disposed inside the cell frame, and general cooling water inside the cell frame (110). The cell frame (110) has a structure in which general cooling water can flow.

The case (121) may be made of a non-polar metal material. The case (121) may be formed of aluminum. In addition, the cooling water supply part (150) may be provided to supply non-insulated cooling water (W).

Referring to FIG. 3, the battery cell (120) comprises a case (121), an upper cover (125), and a lower cover (126). The case (121) made of a non-polar material is non-polar, and when it is immersed in cooling water, it does not cause a chemical reaction with the cooling water, and thus does not corrode. Accordingly, the battery cell (120) according to this example has corrosion resistance and insulation properties even without any separate insulation treatment for the case (121). The case (121) does not require a nickel-plated layer.

The upper cover (125) is a waterproof cover covering the upper surface of the case (121), and the lower cover (126) is a waterproof cover covering the lower surface of the case (121). The upper cover (125) and the lower cover (126) may be provided to prevent the cooling water (W) from permeating into the case (121).

The battery module (100) may comprise waterproof layers (131, 132) provided inside the cell frame (110), and provided to cover an upper side end (127) and a lower side end (128) of the case (121), respectively. The upper waterproof layer (131) may be provided on the upper side end (127) of the case (121), and the lower waterproof layer (132) may be provided on the lower side end (128) of the case (121).

The waterproof layers (131, 132) may comprise a waterproof adhesive or a potting resin, and the potting resin may be any one of a silicone-based resin, a urethane-based resin, and an epoxy-based resin.

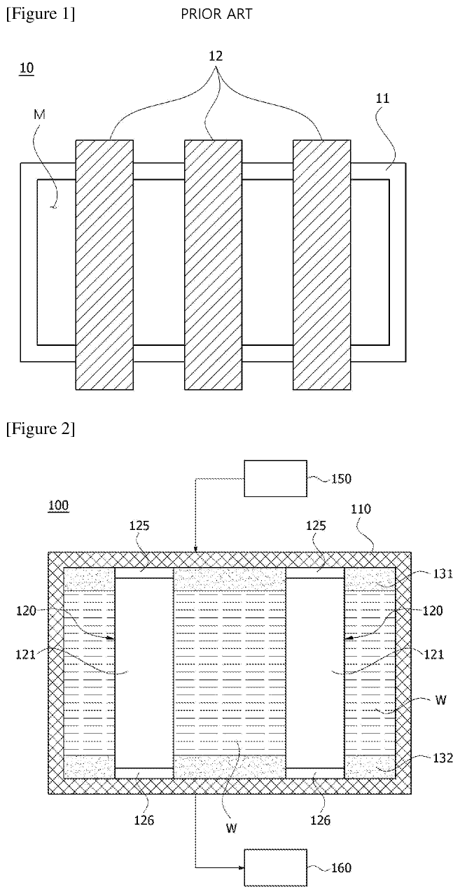

In the battery module (100) according to this example, the outer surface of the battery cell (120) in direct contact with the cooling water has non-polar properties, so that even if it is immersed in the cooling water for a long time, the corrosion resistance and insulation properties of the battery cell (120) are maintained. As a result, when heat is generated in the battery cell (120), the battery cell (120) can be cooled using the non-insulated, general coolant (W) instead of the insulated, special coolant (M, see FIG. 1). The general cooling water (W) may be cooling water generally used in vehicles.

As the case (121) is formed of a non-polar material, the present disclosure can improve corrosion resistance of the battery cell (120) without additional insulation treatment (for example, a nickel-plated layer) on the case (121).

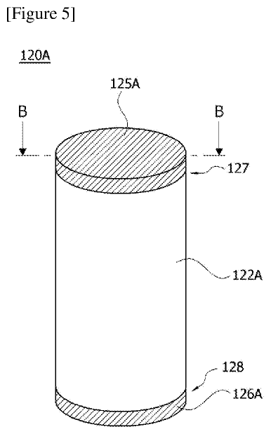

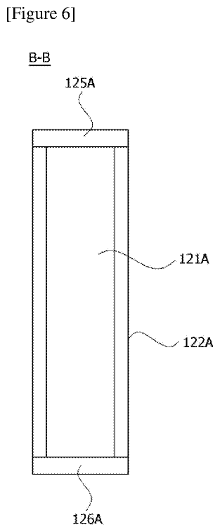

FIG. 4 is a diagram schematically illustrating a configuration diagram of a direct water-cooling battery module according to another example of the present disclosure, FIG. 5 schematically illustrates a perspective diagram of a battery cell according to another example of the present disclosure, and FIG. 6 is a schematic cross-sectional diagram of a battery cell according to another example of the present disclosure.

The battery module (100A) according to a second example is different from the battery module (100) according to the first example only in that it comprises a resin layer (122A) surrounding the case (121A).

A direct water-cooling battery module (100A) according to the second example of the present disclosure will be described with reference to FIGS. 4 to 6. The battery module (100A) comprises a plurality of battery cells (120A) including an electrode assembly, a case (121A) for accommodating the electrode assembly, and a resin layer (122A) surrounding the case; a cell frame (110A) provided that the plurality of battery cells (120A) is spaced apart and disposed therein, and cooling water (W) can flow between the plurality of battery cells; and a cooling water supply part (150A) for supplying the cooling water (W) into the cell frame (110A). Also, the battery module (100A) may comprise a cooling water discharge part (160A) like the first example.

As in the first example, the cell frame (110A) has a structure in which general cooling water (W) can flow. In addition, the cooling water supply part (150A) is provided to supply non-insulated cooling water.

In addition, the battery cell (120A) comprises a case (121A), a resin layer (122A) on the surface of the case (121A) in contact with cooling water, an upper cover (125A), and a lower cover (126A).

The case (121A) may be formed of an aluminum material. The outer surface of the case (121A) may be non-polarized by the resin layer (122A).

The resin layer (122A) may be formed of a polymer sheet, and the resin layer (122A) may be formed by thermally compressing the polymer sheet on the outer surface of the case (121A). The resin layer (122A) may be formed of a polymer sheet having insulation properties and watertightness, and a heat-shrinkable polymer sheet may be used for the resin layer (122A).

For example, the resin layer (122A) may be a sheet made of one or more polymer materials of polyvinylchloride (PVC), polypropylene (PP), and polyethylene terephthalate (PET).

The upper cover (125A) is a waterproof cover covering the upper surface of the case (121A), and the lower cover (126A) is a waterproof cover covering the lower surface of the case (121A). The upper cover (125A) and the lower cover (126A) may be provided to prevent the cooling water (W) from permeating into the case (121A).

The battery module (100A) may comprise waterproof layers (131A, 132A) provided inside the cell frame (110A), and provided to cover the upper side end (127A) and the lower side end (128A) of the case (121A), respectively. The upper waterproof layer (131A) may be provided on the upper side end (127) of the case (121A), and the lower waterproof layer (132A) may be provided on the lower side end (128) of the case (121A).

The waterproof layers (131A, 132A) may comprise a waterproof adhesive or a potting resin, where the potting resin may be any one of a silicone-based resin, a urethane-based resin, and an epoxy-based resin.

In the battery module (100A) according to the second example, the case (121A) of the battery cell (120A) is waterproofed and insulated by the resin layer (122A), the upper cover (125A), and the lower cover (126A), so that even if it is immersed in the cooling water for a long time, corrosion resistance and insulation properties can be maintained.

The examples of the present disclosure as described above have been disclosed for illustrative purposes, and those skilled in the art having ordinary knowledge of the present disclosure will be able to make various modifications, changes, and additions within the spirit and scope of the present disclosure, and such modifications, changes, and additions should be regarded as falling within the scope of the following claims.

### INDUSTRIAL APPLICABILITY

According to a direct water-cooling battery cell related to at least one example of the present disclosure, and a battery module comprising the same, heat generated in the battery cell can be cooled using low-cost, general cooling water instead of insulated, expensive special cooling water.

1. A battery module comprising:
a plurality of battery cells including an electrode assembly;
a case formed of a non-polar material, the case configured to house the electrode assembly therein;
a cell frame in which individual battery cells of the plurality of battery cells is are spaced apart such that cooling water can flow between the plurality of battery cells; and
a cooling water supply part configured to supply the cooling water to an inside of the cell frame.

2. The battery module according to claim 1, wherein
the cooling water supply part is configured to supply non-insulated cooling water.

3. The battery module according to claim 1, wherein
the case is formed of aluminum.

4. The battery module according to claim 1, comprising
a waterproof layer provided inside the cell frame, the waterproof layer configured to cover an upper side end and a lower side ends of the case.

5. The battery module according to claim 4, wherein
the waterproof layer includes a waterproof adhesive or a potting resin.

6. The battery module according to claim 5, wherein
the potting resin is any one of a silicone-based resin, a urethane-based resin, or an epoxy-based resin.

7. The battery module according to claim 1, wherein
the case does not include a nickel-plated layer.

8. A battery module comprising:
a plurality of battery cells including an electrode assembly;
a case configured to house the electrode assembly therein;
a resin layer surrounding the case;
a cell frame in which individual battery cells of the plurality of battery cells are spaced such that cooling water can flow between the plurality of battery cells; and
a cooling water supply part configured to supply the cooling water to an inside of the cell frame.

9. The battery module according to claim 8, wherein
the resin layer is formed of a polymer sheet.

10. The battery module according to claim 9, wherein
the resin layer is formed by thermally compressing the polymer sheet on the outer surface of the case.

11. The battery module according to claim 9, wherein
the polymer sheet is formed of at least one of polyvinylchloride, polypropylene, and polyethylene terephthalate.

12. The battery module according to claim 8, wherein
the cooling water supply part is configured to supply non-insulated cooling water.

13. The battery module according to claim 8, wherein
the case is formed of aluminum.

14. The battery module according to claim 8, comprising
a waterproof layer provided inside the cell frame, the waterproof layer configured to cover an upper side end and a lower side ends of the case.

15. The battery module according to claim 8, wherein
the case does not include a nickel-plated layer.
